(19) United States
(12) Patent Application Publication
(10) Pub. No.: US 2008/0035074 A1
(43) Pub. Date: Feb. 14, 2008

(54) Baby harness

(76) Inventor: Elvira Diez, Port ST. Lucie, FL (US)

Correspondence Address: JAMES RAY & ASSOCIATES, 2640 PITCAIRN ROAD, MONROEVILLE, PA, 15146, US

(21) Appl. No.: 11/891,808

(22) Filed: Aug. 13, 2007

Related U.S. Application Data
(60) Provisional application No. 60/824,659, filed on Sep. 6, 2006.
(60) Provisional application No. 60/837,028, filed on Aug. 11, 2006.

(51) Int. Cl. A62B 35/00; A45F 4/02

(52) U.S. Cl. 119/770; 119/857; 224/153

(57) ABSTRACT

An apparatus for use as a harness for a child so as to ensure that such child is within reach, the apparatus comprises a back pack member having a predetermined shape, a predetermined size and formed of a predetermined material for storing needed items. A securing means is engageable with the back pack and with such child for securing the back pack to such child's body, and an extension lead member is removably engageable with one of the back pack and the securing means for providing a predetermined distance that such child may stray from a care giver.

### CROSS REFERENCE TO RELATED APPLICATIONS

This application is closely related to and claims benefit from U.S. Provisional Application Ser. No. 60/837,028 filed Aug. 11, 2006.

### FIELD OF THE INVENTION

The present invention relates, in general, to a baby harness, and, more particularly, the present invention relates to a child walking harness with a stuffed toy backpack to create a friendly harness.

### BACKGROUND OF THE INVENTION

Toddlers often refuse to ride in strollers and prefer to walk alongside the parent or care giver. When in public locations, the child's attention may be distracted by fun or colorful images, causing them to be separated from the parent or care giver and could get lost in the crowd. Harnesses have been used to effectively allow the child to walk, while ensuring that he or she is always within reach of the parent or care giver. Unfortunately, most children balk at having to wear the utilitarian harness.

Thus, it would be advantageous if there were a harness that could incorporate the safety features of the harness with the fun and playful features of a stuffed toy backpack so that the child and care giver could easily walk together.

### SUMMARY OF THE INVENTION

In a first aspect the present invention provides an apparatus for use as a harness for a child so as to ensure that such child is within reach, the apparatus comprises a back pack member having a predetermined shape, a predetermined size and formed of a predetermined material for storing needed items. A securing means is engageable with the back pack and with such child for securing the back pack to such child's body, and an extension lead member is removably engageable with one of the back pack and the securing means for providing a predetermined distance that such child may stray from a care giver.

### OBJECTS OF THE INVENTION

It is, therefore, one of the primary objects of the present invention to provide a safety harness that incorporates a toy backpack.

Another object of the present invention to provide a safety harness wherein the backpack is shaped like an animal.

Still another object of the present invention to provide a safety harness that also provides storage space for the parent to store necessities.

Yet another object of the present invention to provide a safety harness system that is designed so that the child will actually enjoy wearing it.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a front perspective view of the harness for a child wherein the back pack is in the form of a lion.

FIG. 2 is a back perspective view of the harness shown in FIG. 1 showing a closure means for the back pack.

FIG. 3 is a is a front perspective view of the harness wherein the back pack is in the form of a monkey.

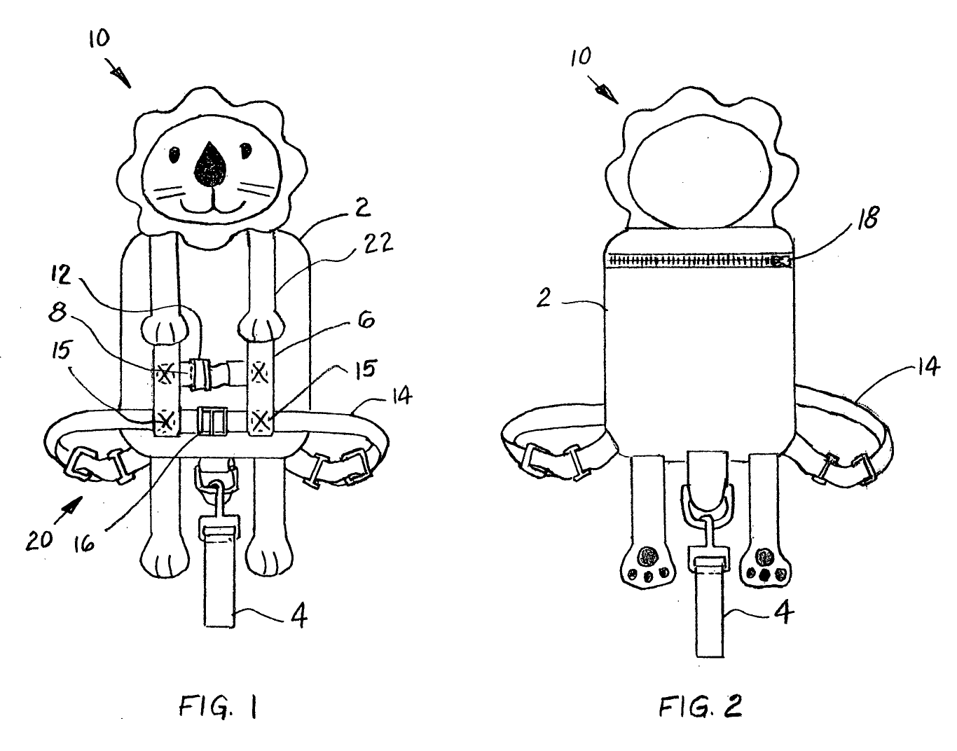

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for use as a harness for a child so as to ensure that such child is within reach. The apparatus comprises a back pack member 2 having a predetermined shape, a predetermined size and formed of a predetermined material for storing needed items. A securing means, generally designated 20, is engageable with the back pack 2 and with such child for securing the back pack 2 to such child's body, and an extension lead member 4 is removably engageable with one of the back pack 2 and the securing means 20 for providing a predetermined distance that such child may stray from a care giver.

The securing means 20 includes a pair of vertically disposed straps 6 that are attached to a first side of the back pack member 2. There is a first pair of horizontally disposed straps 8, each of the first pair of horizontally disposed straps 8 are engageable on a first end thereof with a respective one of the pair of vertically disposed straps 6 intermediate each end thereof. A first closure means 12 is engageable with a second end of the first pair of horizontally disposed straps 6 for securing the second end of one of the first pair of horizontally disposed straps 6 to a second end of another of the first pair of horizontally disposed straps 6. A second pair of horizontally disposed straps 14 is engageable on a first end thereof with a respective radially opposed portion of the back pack 2 and further engageable with a loop member 15 disposed on a bottom portion of each of the pair of vertically disposed straps 6 wherein a second end of each of the second pair of horizontally disposed straps 14 passes through the loop member 15 of a respective one of the pair of vertically disposed straps 6. There is a second closure means 16 for securing the second end of one of the second pair of horizontally disposed straps 14 with a respective second end of another of the second pair of horizontally disposed straps 14 after the second pair of horizontally disposed straps 14 extend around the waist of a child. Such second pair of horizontally disposed straps 14 are adjustable so that they can be adjusted to fit the child snugly.

Such first closure means 12 and the second closure means 16 are selected from one of buckles and a hook and loop arrangement. It is presently preferred that such first and said second closure means 12,16 are buckles and that such buckles are side release buckles. The side release buckles are easy to connect and disconnect.

It is presently preferred that such pair of vertically disposed straps 6 are engageable on a first end thereof with an end of each of a respective one of a pair of front legs 22 of the animal used to form the predetermined shape of such back pack member 2.

It is also presently preferred that such predetermined material for making the back pack 2 is fabric. And that such fabric is polyester.

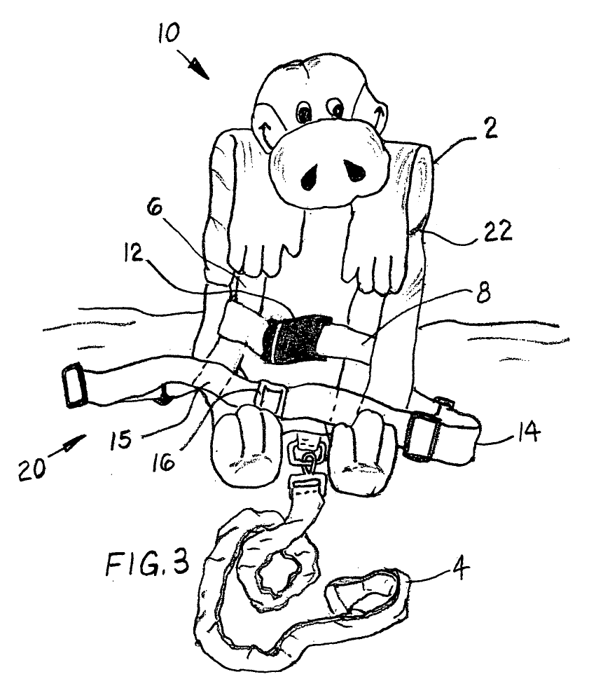

The predetermined shape of said back pack member is selected from one of animals, sports figures, racing cars, and cartoon characters. The shape should be something that the child is familiar with and enjoys. Presently, it is preferred that such shape is one of animals having at least a head and legs formed thereon and that such animal is selected from a group including a monkey, lion, dog, cat, leopard and tiger. It is within the scope of the invention that animals other than those listed could be used for the shape of the back pack 2. FIG. 1 and 3 show animals as the back pack 2 but as mentioned previously the shape of the back pack 2 could also be cartoon characters, such as Spiderman, Superman or any of the favorite cartoon characters seen on TV or it could also be sports figures.

The back pack 2 further includes a means for closing the back pack 2 so as to keep any item stored within safe. Such closing means is selected from one of a zipper, a hook and loop arrangement and buckles. Presently it is preferred that such closing means is a zipper 18.

The extension lead 4 is engageable with such back pack 2 and is basically engageable with what would be the tail of the animal and such extension lead 4 is designed in the form of a tail of whatever animal shape the back pack 2 is designed for. It is presently preferred that such extension lead member 4 is made of polypropylene. Again, as stated previously such extension lead member is removably engageable with such back pack 2 and can be removed when it is no longer required by such child. The extension lead member 4 is approximately 40 inches long which gives the child some room to roam but is still within the care givers range.

Thus the present invention provides a harness for a toddler or a child that is in the form of a friendly animal. It keeps the child close to the parent or guardian by the tail of the animal but gives the child enough room to feel free yet close enough in case the parent or guardian has to reach for the child. The harness has an adjustable strap so as to fit the child snugly but tight enough to annoy the child yet snug enough to prevent the child from getting loose.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for use as a harness for a child so as to ensure that such child is within reach, said apparatus comprising:
(a) a back pack member having a predetermined shape, a predetermined size and formed of a predetermined material for storing needed items;
(b) a securing means engageable with said back pack and with a child for securing said back pack to such child's body; and
(c) an extension lead member removably engageable with one of said back pack and said securing means for providing a predetermined distance that such child may stray from a care giver.

2. The apparatus, according to claim 1, wherein said securing means includes:
(a) a pair of vertically disposed straps attached to a first side of said back pack member,
(b) a first pair of horizontally disposed straps, each of said first pair of horizontally disposed straps engageable on a first end thereof with a respective one of said pair of vertically disposed straps intermediate each end thereof;
(c) a first closure means engageable with a second end of said first pair of horizontally disposed straps for securing said second end of one of said first pair of horizontally disposed straps to a second end of another of said first pair of horizontally disposed straps;
(d) a second pair of horizontally disposed straps engageable on a first end thereof with a respective radially opposed portion of said back pack and further engageable with a loop member disposed on a bottom portion of each of said pair of vertically disposed straps wherein a second end of each of said second pair of horizontally disposed straps passes through said loop member of a respective one of said pair of vertically disposed straps; and
(e) a second closure means for securing said second end of one of said second pair of horizontally disposed straps with a respective second end of another of said second pair of horizontally disposed straps after said second pair of horizontally disposed straps extend around a waist of a child.

3. The apparatus, according to claim 2, wherein said second pair of horizontally disposed straps are adjustable.

4. The apparatus, according to claim 2, wherein said first closure means and said second closure means are selected from one of buckles and a hook and loop arrangement.

5. The apparatus, according to claim 4, wherein said first and said second closure means are buckles.

6. The apparatus, according to claim 2, wherein said buckles are side release buckles.

7. The apparatus, according to claim 1, wherein said predetermined material is fabric.

8. The apparatus, according to claim 7, wherein said fabric is one of polyester and nylon.

9. The apparatus, according to claim 1, wherein said predetermined shape of said back pack member is selected from one of animals, sports figures, racing cars, and cartoon characters.

10. The apparatus, according to claim 9, wherein said predetermined shape is in a form of an animal having at least a head and legs formed thereon.

11. The apparatus, according to claim 10, wherein said animal is selected from one of a monkey, lion, dog, cat, leopard and tiger.

12. The apparatus, according to claim 1, wherein said back pack further includes a means of closing said back pack.

13. The apparatus, according to claim 12, wherein said means for closing said back pack includes one of a zipper, a hook and loop arrangement and buckles.

14. The apparatus, according to claim 13, wherein said means for closing said back pack is a zipper.

15. The apparatus, according to claim 1, wherein said extension lead is engageable with said back pack.

16. The apparatus, according to claim 15, wherein said extension lead is in a form of an animals tail.

17. The apparatus, according to claim 1, wherein said extension lead member is formed of polypropylene.

18. The apparatus, according to claim 1, wherein said extension lead is removed when it is no longer required by such child.

19. The apparatus, according to claim 1, wherein said extension lead is approximately 40 inches long.

20. The apparatus, according to claim 2, wherein each of said pair of vertically disposed straps are engageable on a first end thereof with an end of each of a respective one of a pair of front legs of an animal used to form said predetermined shape of said back pack member.
